(19) United States
(12) Patent Application Publication
(10) Pub. No.: US 2026/0227667 A1
(43) Pub. Date: Aug. 6, 2026

(54) SEGMENTED ELECTROCHROMIC ELEMENT DRIVER

(71) Applicant: Gentex Corporation, Zeeland, MI (US)

(72) Inventors: Robert R. Turnbull, Holland, MI (US); Nicholas Young, Jenison, MI (US)

(73) Assignee: Gentex Corporation, Zeeland, MI (US)

(21) Appl. No.: 19/152,034

(22) PCT Filed: Dec. 30, 2024
(86) PCT No.: PCT/IB2024/063313

§ 371 Date: Jul. 30, 2025

Related U.S. Application Data
(60) Provisional application No. 63/616,915, filed on Jan. 2, 2024.

(51) Int. Cl. G02F 1/163

(52) U.S. Cl. CPC G02F 1/163

(57) ABSTRACT

An electro-optic control apparatus includes a common driver in conductive connection with a plurality of electro-optic elements at a first terminal. Each of the electro-optic elements is connected to a dedicated driver at a second terminal. The dedicated drivers are separated from the common driver over an electro-optic medium of each of the plurality of electro-optic elements. The electro-optic medium of each of the electro-optic elements is configured to vary in light transmittance in response to a voltage difference between the common driver and the corresponding dedicated driver.

### CROSS-REFERENCE TO RELATED APPLICATION

This application claims priority to and the benefit under 35 U.S.C. § 119(e) of U.S. Provisional Patent Application No. 63/616,915, filed on Jan. 2, 2024, entitled “SEGMENTED ELECTROCHROMIC ELEMENT DRIVER,” by Robert R. Turnbull et al., the entire disclosure of which is incorporated herein by reference.

### BACKGROUND OF THE INVENTION

The present invention relates to a drive circuit for an electro-optic device.

### SUMMARY OF THE INVENTION

The disclosure may generally provide for an improved control circuit for electro-optic elements that may be controlled to vary in light transmittance. In various implementations, the control apparatus includes a common driver in conductive connection with a plurality of electro-optic elements at a first terminal. Each of the electro-optic elements is further connected to a dedicated driver at a second terminal. The dedicated drivers are separated from the common driver over an electro-optic medium of each of the plurality of electro-optic elements. The electro-optic medium of each of the electro-optic elements is configured to vary in light transmittance in response to a voltage difference between the common driver and the corresponding dedicated driver.

In some implementations, the disclosure may provide for a method of independently controlling a transmittance of a plurality of electro-optic elements via conductive contacts including a common control node. The method includes supplying a consistent common control signal to the common control node. A first transmittance of a first electro-optic element is controlled by selectively applying a positive voltage difference or a negative voltage difference across the first electro-optic medium relative to the common node. The positive voltage difference corresponds to a range of voltages that adjust the first transmittance over a range of transmittances. The negative voltage difference corresponds to a range of voltages that adjust a rate of clearing the first transmittance from the range of transmittances.

In yet another implementation, the disclosure may provide for an electro-optic control apparatus including a common driver in conductive connection with a plurality of electro-optic elements. Each of the electro-optic elements may include an electro-optic medium connected via a common node shared between or among the plurality of electro-optic elements. In operation, the common driver supplies a common drive signal to the common node of the plurality of electro-optic elements. The electro-optic control apparatus further includes a plurality of dedicated drivers in conductive connection with each of the plurality of electro-optic elements via a plurality of independent control nodes. The independent control nodes are connected across at least a portion of the electro-optic medium relative to the common node.

These and other features, objects and advantages of the present invention will become apparent upon reading the following description thereof together with reference to the accompanying drawings.

### BRIEF DESCRIPTION OF THE DRAWINGS

FIG. 1A is an environmental view demonstrating exemplary applications for an electro-optic device;

FIG. 1B is a projected view of an aircraft demonstrating exemplary applications for an electro-optic device;

FIG. 1C is a projected view of eyewear or a wearable device demonstrating exemplary applications for an electro-optic device;

FIG. 2A is a schematic diagram of a control device for a plurality of electro-optic elements comprising a common driver;

FIG. 2B is a schematic diagram of a control device for a plurality of electro-optic elements comprising a common driver;

FIG. 2C is a schematic diagram of a control device for a plurality of electro-optic elements;

FIG. 3 is a schematic diagram of an exemplary electro-optic device demonstrating a control device for at least one electro-optic element;

FIG. 4 is a schematic diagram of a control device for an electro-optic element;

FIG. 5 is a schematic diagram of a control device for a plurality of electro-optic elements; and

FIG. 6 is a block diagram of an exemplary controller for at least one electro-optic element in accordance with the disclosure.

### DETAILED DESCRIPTION OF THE PREFERRED EMBODIMENT

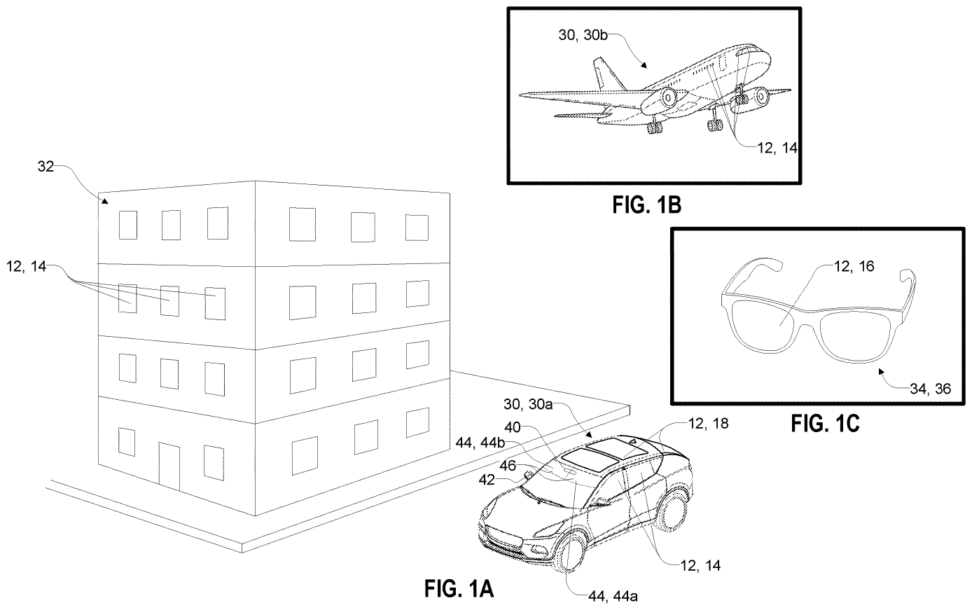

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the element closer to an intended viewer of the display mirror, and the term “rear” shall refer to the surface of the element further from the intended viewer of the display mirror. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

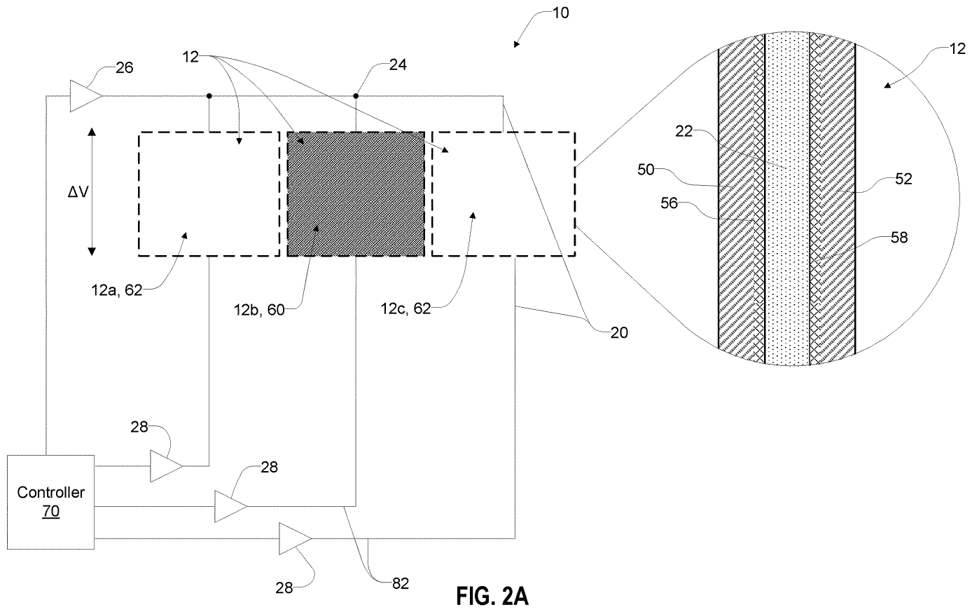

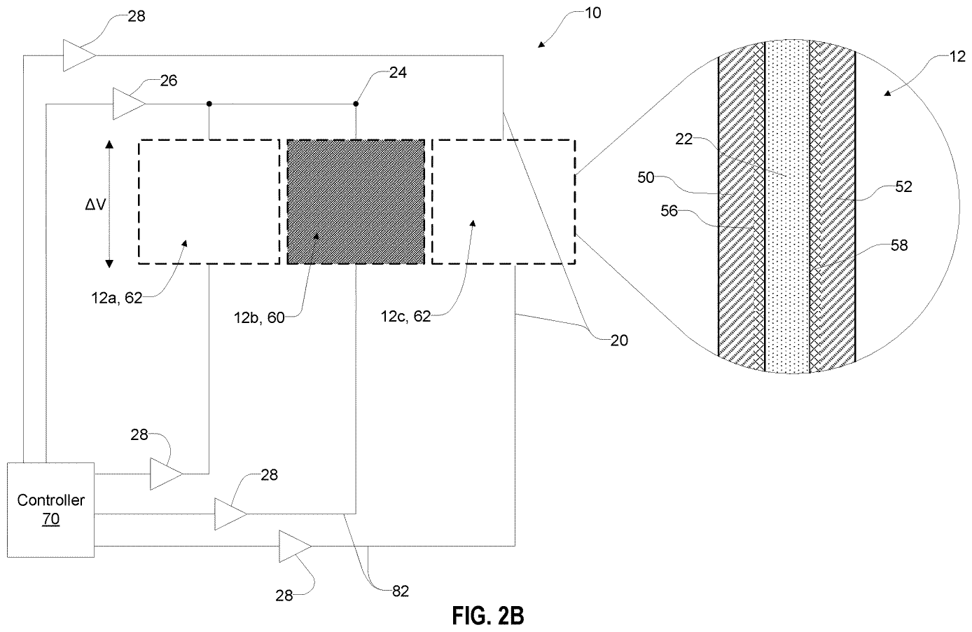

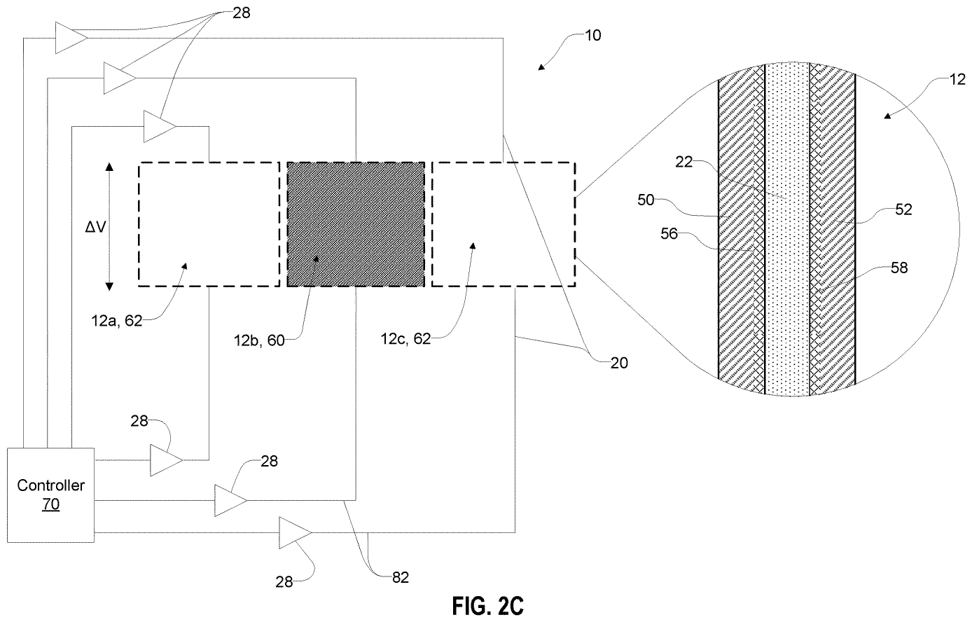

Referring to FIGS. 1 and 2, the disclosure provides for a control system 10 that may incorporate a variety of control circuits and corresponding methods for manipulating or controlling the transmittance of one or more electro-optic elements 12. As provided in various implementations, the electro-optic elements 12 may correspond to light transmissive windows 14, lenses 16, panels 18, or various structures that may be controlled to vary in light transmittance. As discussed later in further detail, each of the electro-optic elements 12 may be controlled to vary in light transmittance by adjusting a voltage difference ΔV across opposing terminals 20 of the electro-optic elements 12 separated by an electro-optic medium 22. As illustrated in FIG. 2A, in various implementations, two or more of the electro-optic elements 12 may be conductively connected to a common node or terminal 24 of a common driver 26. Opposite the common terminal 24 across the electro-optic medium 22, each of the electro-optic elements 12 may be connected to a separate or dedicated driver 28. As provided in various examples in the following detailed description, the voltage difference ΔV across each of the electro-optic elements 12 may be independently controlled by adjusting the voltage of each of the dedicated drivers 28 relative to the voltage of the common driver 26 at the common terminal 24. Further, as provided in various examples, the voltage applied to each of the electro-optic elements 12 may only be required to vary over a positive voltage range, which may simplify the operation of the control system 10 and the associated hardware. Accordingly, the control system 10 may provide for expedient and accurate control of the transmittance of each of the electro-optic elements while limiting power usage.

As demonstrated in FIGS. 1A-1C, the electro-optic elements 12 may be implemented in a variety of applications. As previously discussed, the electro-optic elements 12 may be incorporated into or form one or more light transmissive windows 14, lenses 16, panels 18 or various light transmissive structures. The windows 14 or panels may be implemented in vehicles 30, buildings 32, wearable devices 34, eyewear 36 or various applications that may be supported by the disclosure. As shown, vehicles 30 may include passenger vehicles 30a and aircraft 30b. Additionally, it shall be understood that various transport vehicles including boats, trailers, trains, spacecraft, gondola lifts, cable cars, or other vehicles may include the electro-optic elements 12 and the control system 10 disclosed.

As shown in FIG. 1A, the electro-optic element 12 is implemented in the windows 14, panels 18, as well as an interior rearview mirror 40, and an exterior mirror 42. In some implementations, the electro-optic element 12 may be implemented in one or more segments 44a, 44b of a windshield 44 and may correspond to dimmable visors 46, which may be mounted within vehicles and/or integrally formed into the glass of the windscreen or front window 14. In various implementations, the electro-optic element 12 may correspond to a plurality of segments comprising independently controlled portions that may be selectively adjusted in transmittance by the control system 10. As demonstrated in further examples shown in FIGS. 1A, 1B, and 1C, the electro-optic elements 12 may be implemented in the windows 14 of a building window, a vehicle windshield, a vehicle side window, a vehicle rear window, a sunroof, a dashboard panel, a divider, mirrors, switchable concealment panels, switchable partitions, and the like. Accordingly, the electro-optic element 12 and control system 10 may be implemented in a variety of applications.

Referring to FIG. 2A, the control system 10 is described in further detail in reference to a plurality of electro-optic elements 12 comprising a first electro-optic element 12a, a second electro-optic element 12b, and a third electro-optic element 12c. As shown in the detailed cross-section relative to the third electro-optic element 12c, each of the electro-optic elements 12 may comprise a first substrate 50 and a second substrate 52 separated by an electro-optic medium 22. In operation, the common driver 26 may control a voltage of the common node 24, which may control the voltage associated with a first electrode 56 of each of the electro-optic elements 12. As shown, the first and second substrates 50, 52 may be disposed in a spaced-apart relationship relative to each other and separated by the electro-optic medium 22. The electro-optic medium 22 may further separate the first electrode 56 disposed on the first substrate 50 from a second electrode 58 disposed over the second substrate 52. In this configuration, the second electrode 58 of each of the electro-optic elements 12 may be connected to separate, dedicated drivers 28 or drive terminals that may be adjusted in voltage to independently control the voltage difference ΔV across each of the electro-optic elements 12.

In operation, the independent control of the transmittance of the electro-optic elements 12 may be provided by independently adjusting the voltage difference applied to each of the electro-optic elements 12a, 12b, and 12c. For example, as previously discussed, the voltage of the common driver 26 terminal may be controlled to a substantially constant voltage (e.g., 1.2V) while the dedicated drivers 28 or terminals may be controlled to vary the voltage difference ΔV applied across each of the electro-optic elements 12a, 12b, and 12c over a voltage range (e.g., 0V-2.4V). In this way, each of the individual electro-optic elements 12 may effectively have a negative voltage difference −ΔV (e.g., −1.2V) or positive voltage difference +ΔV (e.g., 1.2V) applied across the electro-optic medium 22 relative to the constant voltage of the common node 24. As a result, the voltage difference ΔV may be selectively applied across each of the electro-optic elements 12 to drive the transmittance from a darkened, light-blocking state 60 to a lightened, light-transmitting state 62 in response to the voltage difference applied thereto. With this control method, the transmittance may be actively adjusted between the light-blocking state 60 to a light-transmitting state 62 while only applying a positive voltage to the common node or terminal 24 as well as each of the opposing terminals of the dedicated drivers 28.

Still referring to FIGS. 1 and 2, the wide variety of applications of the electro-optic elements 12 may be supported by various material selections and constructions. In various examples, the first and second substrates 50, 52 may be formed of various materials. For example, the first and second substrates 50, 52 may be formed of plastic materials, such as a clear polycarbonate, polyethylene terephthalate (PET), polyamide, acrylic, cyclic olefin, polyethylene (PEN), metallocene polyethylene (mPE), silicone, urethane, and various polymeric material; and/or formed of glass, such as, soda lime float glass, borosilicate glass, boro-aluminosilicate glass, or various other compositions. Further, glass substrates, may be annealed, heat strengthened, chemically strengthened, tempered, or safety glass. The electro-optic medium 22 disposed between the first and second substrate 50, 52, for example, may be an electrochromic medium, a liquid crystal medium, electrophoretic medium, or a suspended particle medium.

In various implementations, the first and second electrodes 56, 58 may be electrically conductive and substantially transparent in the visible spectrum. For example, the first and second electrodes 56, 58 may be a transparent conductive oxide (TCO), such as fluorine doped tin oxide (FTO), indium tin oxide (ITO), aluminum doped zinc oxide (AZO), or indium zinc oxide (IZO). Accordingly, the first and second electrodes 56, 58, in conjunction, may be operable to apply the electrical potential and/or field to electro-optic medium 22. Accordingly, the construction of the electrodes 56, 58 may similarly vary to support a broad range of applications of the electro-optic elements 12.

In some embodiments, electro-optic medium 22 may comprise at least one solvent, at least one anodic material, and/or at least one cathodic material, which may be suspended in a fluid solution. In other embodiments, the electro-optic medium 22 may comprise at least one anodic material and/or at least one cathodic material suspended in a matrix. Such a construction may be referred to as having memory chemistry. In such embodiments, the electro-optic medium 22 may be operable to enter and/or maintain an activated state upon exposure to an electrical potential. In some embodiments, such as solution phase embodiments, electro-optic medium 22 may be operable to automatically revert to a neutral or inactive state upon removal of the electrical potential. In other embodiments, such as memory chemistry embodiments, electro-optic medium 22 may be operable to maintain the activated state until exposure to a different electrical potential. In some instances, the different electrical potential may be a short of the electrical circuit and, thus, a substantially zero potential. Additionally, the term “electrochromic” will be defined herein, regardless of its ordinary meaning, as a material that exhibits a change in its extinction coefficient at one or more wavelengths upon exposure to a particular electrical potential difference. Accordingly, in an activated state, electro-optic medium 22 may be operable to exhibit a change, relative to the neutral or inactive state, in its extinction coefficient at one or more wavelengths in the electromagnetic spectrum. In some embodiments, this change may occur in the visible region of the electromagnetic spectrum. In other words, the electrochromic medium may be variably transmissive or operable to dim.

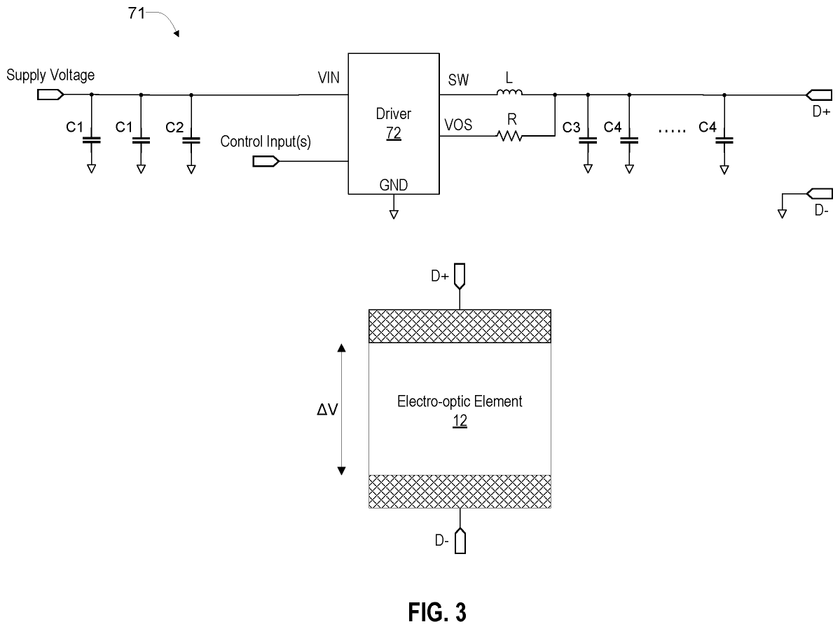

Still referring to FIG. 2, the drivers 26, 28 as discussed herein may correspond to linear drivers (e.g., operational amplifiers), switchmode devices (synchronous buck converters, step-down converters, etc.), and various devices that may be configured to output a controlled voltage while also providing for current sourcing and sinking capabilities. As provided in the detailed examples shown in FIGS. 3-5, the drivers may be in communication with one or more controllers or control circuits, which may correspond to a control bus output from the central controller 70. The control signals may correspond to outputs from digital-to-analog converters (DACs), pulse width modulated signals, or signals communicated over a control bus. An example of a control bus communication may include an inter-integrated circuit (12C) protocol or similar communication protocols that may be configured to control multiple peripheral devices, for example the drivers 26, 28, in coordination. While the specific control signals required to control each of the drivers 26, 28 may vary in reference to the applications of the control system 10, the control schemes for the specific hardware devices may be provided by the technical specifications for the corresponding devices and their data sheets. Accordingly, the input signals supplied to each of the drivers described in reference to FIGS. 3-5 are generally referred to as control inputs. Some examples of drivers that may be implemented to achieve the operations described may include linear drivers, such as the ALM2402 Dual Op-Amp by Texas Instruments and switchmode drivers, such as the TPS628600 Synchronous Step Down Converter from Texas Instruments. Another example of a switchmode driver may include the FAN53730 Buck Regulator by Onsemi. The applications of these devices may be readily understood by the operation of the circuit schematics that follow.

Referring now to FIG. 2B, in some implementations, the common driver 26 and common node 24 of the system 10 may be connected to the first electro-optic element 12a and the second electro-optic element 12b. In such implementations, the third electro-optic element 12c may be connected to dedicated drivers 28 at both the anodic and cathodic electrodes 56, 58. Further, as shown in FIG. 2C, in some implementations, the electro-optic element 12a, 12b, 12c may not share the common node 24. In such implementations, the anodic and cathodic electrodes 56, 58 of each of the electro-optic element 12a, 12b, 12c may be connected to one of the dedicated drivers 28. In general, the implementation of the common driver configurations shown in FIG. 2A, the hybrid configuration of FIG. 2B, and the dedicated driver configuration of FIG. 2C may be determined based on a variety of factors including, but not limited to, the scale of the electro-optic elements 12, budget, and material constraints, as well as the responsiveness of the resulting systems. Accordingly, each of the control systems 10 may operate similarly as later discussed in reference to FIGS. 3-5 and the different configurations shown in FIGS. 2A-2C may be implemented alone or in various combinations.

Referring to FIGS. 2B and 2C, the utilization of the dedicated drivers 28 in connection with the anodic and cathodic electrodes 56, 58 may provide for added control of a voltage difference ΔV across each of the corresponding electro-optic element 12a, 12b, and/or 12c. For example, as later discussed in reference to FIGS. 3-5, the drivers 26, 28 may include feedback control circuits and corresponding control methods that may improve the control accuracy of the control voltages supplied to the drive nodes (D+, D−) of the electro-optic elements 12. Additionally, the configurations of FIGS. 2A, 2B, and 2C are capable of both sinking and sourcing current over a range of output voltages. Such sourcing and sinking operation may ensure that the electro-optic elements 12 (12a, 12b, 12c, etc.) may be actively driven between the darkened, light-blocking state 60 and the lightened, light-transmitting state 62. Further, the active sourcing and sinking operation of the drivers as described herein may ensure that the corresponding circuits may be implemented to support the operation of a variety of electrochromic chemistries to control the transition between the transmittance states 60, 62. Accordingly, depending on the application of the electro-optic elements 12 and the drivers 26, 28, the different configurations presented in FIGS. 2A-2C may provide for various optional configurations to suit a wide variety of designs.

Referring now to FIG. 3, a simplified example of a drive circuit 84 is described in reference to an exemplary electro-optic element 12 for clarity. In the examples shown, the driver 72 may correspond to a switchmode driver that may be controlled via an 12C bus for a selectable logic control via the control inputs. In response to the control inputs, the device switching node SW may actively control a voltage output to a positive drive node (D+) across an inductor L. As shown, the device switching node SW is further in connection with a voltage output sense pin VOS input across a resistor R, which may be optionally replaced with a short (zero Ohms). In operation, the control inputs supplied to the driver 72 may drive the positive drive node (D+) between a high voltage (e.g., 3V) and a low voltage (e.g., 0-0.5V) to create a voltage difference ΔV between the positive drive node (D+) and the negative drive node (D−). In the example shown, the negative drive node (D−) or the cathodic node may be connected to ground, such that the voltage difference ΔV is defined relative to the ground voltage level of the driver 72. In this way, the voltage difference ΔV across the electro-optic element 12 may be actively controlled to adjust the transmittance of the electro-optic element. In addition to the inductor L and the resistor R, the signal supplied to the voltage input VIN of the driver 72 and the voltage output supplied to the positive drive node (D+) may be connected to the ground GND via one or more capacitors to condition or stabilize the corresponding voltage signals. In the example shown, the stabilizing capacitors may include the first capacitor C1, a second capacitor C2, and a third capacitor C3. Additionally, a fourth capacitor C4 may provide direct feedback from the switching driver output at high frequencies to maintain control loop stability even if the amplifier 82 is relatively slow. Accordingly, the control circuit 94 may provide for an actively driven arrangement to control the transmittance of the electro-optic element 12.

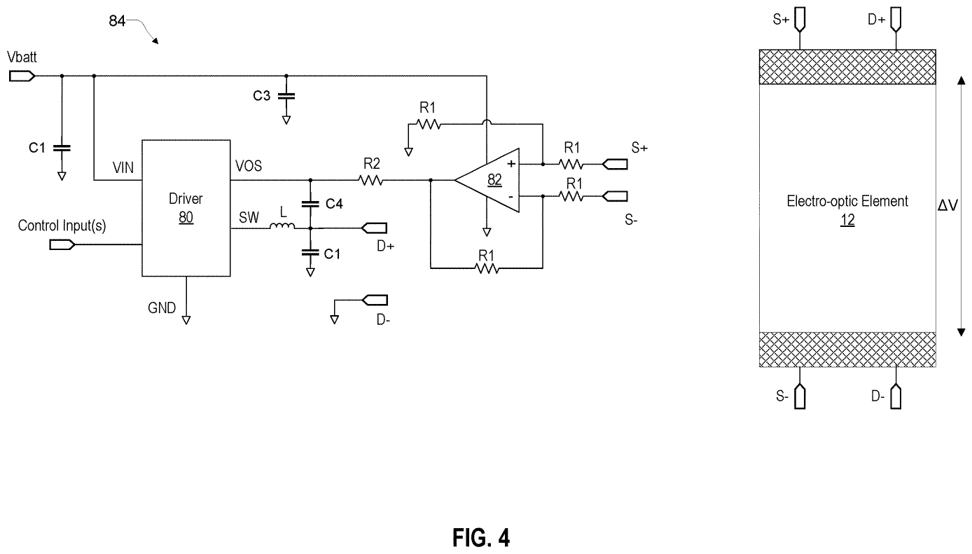

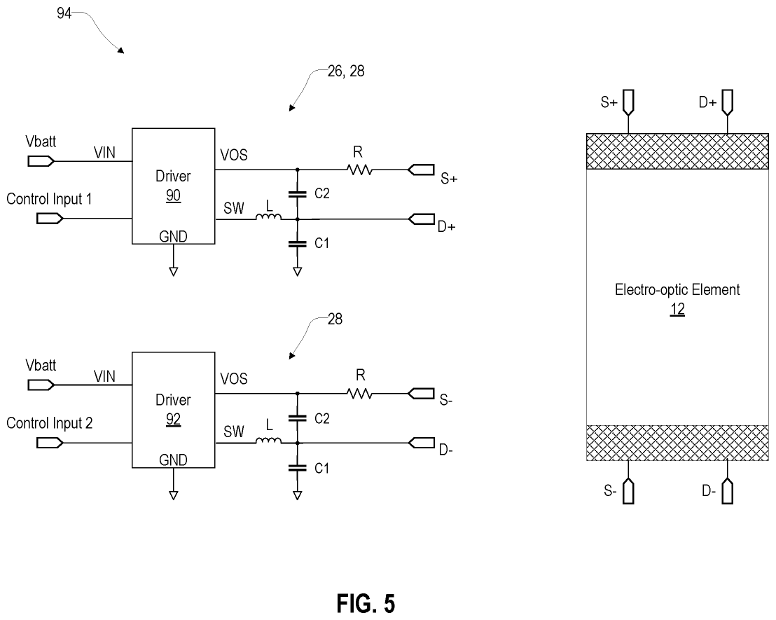

Referring now to FIGS. 4 and 5, in some implementations, the transmittance of the electro-optic elements 12 may further be monitored via a plurality of feedback inputs supplied to control driver 80, 90, 92. The examples of FIGS. 4 and 5 may correspond to battery-operated devices that may operate at low power, which may be advantageous for various mobile or portable implementations of the electro-optic elements 12, for example, the wearable devices 34 or eyewear 36. Referring first to FIG. 4, the driver 80 may be in the form of a synchronous buck converter comprising a switch pin SW connected to the positive drive terminal (D+) across an inductor L. Opposite the positive drive terminal (D+) across the electro-optic element 12, a negative drive terminal (D−) may be connected to the ground GRD of the driver 80. In this configuration, the driver 80 may be configured to control the voltage supplied to the opposing terminals electro-optic element 12.

As further demonstrated in FIG. 4, the driver 80 may be configured to monitor the effective voltage difference ΔV across the positive drive terminal (D+) and the negative drive terminal (D−). The voltage difference ΔV may be monitored by the driver as the difference between a positive voltage feedback (S+) and a negative sensing feedback (S−) output from an operational amplifier 82. As shown, the output of the operational amplifier 82 may be in connection with a voltage output sense pin VOS of the driver 80 to identify the voltage difference ΔV across the terminals of the electro-optic element 12. More specifically, the voltage feedback connections (S+), (S−) may be connected to the non-inverting and inverting inputs of the operational amplifier 82 and configured to output a voltage difference representative of the difference in voltage ΔV across the electro-optic element 12 to the output voltage sense pin VOS of the driver 80. In this way, the driver 80 may accurately detect the voltage difference ΔV across the electro-optic element 12 to accurately control the voltage to the positive drive input (D+).

In operation, the driver 80 may monitor the voltage feedback connections (S+) and (S−) to accurately detect the voltage difference ΔV between the anodic and cathodic electrodes 56, 58. For example, due to cost, design requirements, and/or material constraints, the voltage difference ΔV across the electro-optic medium 22 may differ significantly from the voltage supplied to the drive terminals (D+, D−). A primary factor leading to this variation is a voltage drop commonly referred to as an IR drop that may be associated with the resistance of the anodic and cathodic electrodes 56, 58 or other conductors incorporated in the system 10. However, the current through the voltage feedback connections (S+) and (S−) may be very low (e.g., in the range of 5-400 millivolts or less). Accordingly, the feedback signals communicated via voltage feedback connections (S+, S−) may be less susceptible and accurately report the voltage difference ΔV. The voltage detected on the voltage feedback connections (S+, S−) is fed back to voltage sense pin VOS pin. In this way, the driver 80 may accurately monitor the voltage difference ΔV across the electro-optic medium 22 and correct the voltages supplied to the drive terminals (D+, D−). By accurately detecting the voltage difference ΔV across the electro-optic medium 22, the driver 80 may offset the voltages supplied to the drive terminals (D+, D−) to account for a voltage drop or IR drop. By accurately monitoring the voltage difference ΔV across the electro-optic medium 22, the control system 10 may improve the operation of the electro-optic element 12 despite various inefficiencies (e.g., resistance or contact losses).

As shown, the drive circuit 84 associated with the driver 80 may incorporate various circuit components, including one or more stabilizing capacitors C1, C3 as well as op-amp gain resistors R1, associated with the operation of the operational amplifier 82. In some implementations, a capacitor C4 and resistor R2 may be incorporated in the drive circuit 84, which may allow the operational amplifier 82 to respond more slowly to differences in the voltage ΔV communicated by the sensory input terminals (S+), (S−). The slower response of the operational amplifier 82 may allow the device to operate with limited power consumption. In the example shown, the capacitor C4 may have a capacitance of approximately 1000 pF and the resistor R2 may have a resistance of approximately 10,000 kΩ. Accordingly, the drive circuit 84 may be configured to control the state of one or more electro-optic elements 12 by accurately and efficiently controlling the voltage difference ΔV applied across the electro-optic elements.

Referring now to FIG. 5, a control circuit 94 may be configured to control the transmittance of the electro-optic element 12 similarly via a positive drive terminal (D+) and a negative drive terminal (D−), as well as a corresponding positive sense terminal (S+) and negative sense terminal (S−). In the example shown, the driver 90 may correspond to a common driver 26 and the driver 92 may correspond to a dedicated driver 28. As described in the example of FIG. 4, the drivers 90, 92 may be implemented by the synchronous buck converters that may be capable of both sinking and sourcing current over a range of output voltages. As shown, the driver 90 may correspond to an anode or positive driver, similar to the common driver 26, and the driver 92 may correspond to a cathode or “negative” driver, similar to the dedicated driver 28. Though described as a negative driver, the negative drive terminal (D−) of the driver 92 may operate to have a higher electrical potential than the driver 90 in a sourcing configuration. Accordingly, the negative and positive nomenclature may be used to describe the relationship of the drivers based on convention to describe the operation consistently in reference to the electro-optic element 12.

Similar to the driver 80, the driver 90 may include the switch pin SW connected to an inductor L and further connected to the positive drive terminal (D+). The driver 92 may have its switch pin SW connected to an inductor L and further connected to the negative drive terminal (D−). In this configuration, the voltage output provided to the positive drive terminal (D+) and negative drive terminal (D−) may be varied over a positive voltage range, for example, from approximately 0 volts to 5 volts, 0.2 volts to 3 volts, or approximately 0.3 volts to 2 volts. The range of voltage outputs may vary based on the specific driver selected and the corresponding power supply provided, which may vary widely depending on the application of control circuit 94. Accordingly, the control circuit 94 may be implemented to suit a variety of applications.

Still referring to FIG. 5, each of the drivers 90, 92 may include a first capacitor C1 connected between the positive and negative drive terminals (D+), (D−) and the ground GND to stabilize the corresponding output voltages. The positive sense terminal (S+) and negative sense terminal (S−) may be connected to the output voltage sense pins VOS of each of the drivers 90, 92, respectively. A second capacitor C2 may be connected across the input of the output voltage sense pin VOS and the corresponding drive pin (D+), (D−) of each of the drivers 90, 92 to optionally stabilize the voltage levels monitored by the positive sense terminal (S+) and the negative sense terminal (S−) across a resistor R. In this way, each of the drivers 90, 92 may accurately control the transmittance of a plurality of electro-optic elements 12 in accordance with the disclosure.

Referring generally to FIGS. 2A, 2B, 2C and 5, the drivers 90, 92 may be configured to operate with the common driver 26 or with various combinations of the dedicated drivers 28. Though discussed specifically in reference to the common driver, the drivers 90, 92 may similarly be implemented with dedicated drivers 28 in connection with both the anodic and cathodic electrodes 56, 58. The primary difference in these applications is that implementations of the drivers 90, 92 each as dedicated drivers 28 may provide for the voltage level at each of the terminals (D+, D−) to be controlled independently for each of the electro-optic elements 12 due to the omission of the common node 24 depending on the specific design configuration (e.g., FIG. 2B, FIG. 2C, etc.) Accordingly, implementations with dedicated drivers 28 controlling the voltage supplied to each of the drive terminals (D+, D−) may be implemented to provide additional control by independently adjusting and correcting the voltage to each of the terminals (D+, D−) based on similar feedback and operating principles described throughout the disclosure.

As shown in FIG. 5, the driver 90 is demonstrated as corresponding to either the common driver 26 or one of the dedicated drivers. For clarity, the description of the driver 90 is described in reference to the common driver configuration. Accordingly, the voltage supplied to the positive drive terminal (D+) of the first driver 90 may be supplied at a substantially constant output voltage. Further, the opposing negative drive voltage communicated by the negative drive terminal (D−) may be controlled by the central controller 70 to vary from approximately 0 volts to a positive voltage in excess of the constant voltage supplied to the positive drive terminal (D+). For example, the positive drive terminal (D+) may be controlled to consistently supply approximately 1.2 volts of electrical potential, while each of the negative drive terminals (D−) of the second driver 92, implemented as a dedicated driver 28, may vary from approximately 0 volts to approximately 2.4 volts in response to control inputs supplied by the central controller 70. In this way, the transmission of the plurality of electro-optic elements 12a, 12b, 12c, may be controlled to vary by adjusting the voltage level of the negative drive terminals (D−) associated with each of the dedicated drivers 28.

As previously discussed, each of the drivers, including the common driver 26 and the dedicated drivers 28, may operate to selectively source current to the electro-optic element 12 or sink current from the electro-optic element 12. For example, in cases where the dedicated driver 28 (e.g., driver 92) is controlled to a voltage level less than the common driver 26 (e.g., driver 90), the dedicated driver 28 may sink current, while the common driver 26 may source current. Alternatively, in cases where the voltage level of the negative drive terminal (D−) of the dedicated driver 28 is set to a voltage in excess of or greater than the voltage of the positive drive terminal (D+) of the common driver 26, the dedicated driver 28 may source current to the electro-optic element 12 while the common driver 26 may sink current from the electro-optic element 12. Such sourcing and sinking operation may ensure that the electro-optic elements 12 (12a, 12b, 12c, etc.) may be actively driven between the darkened, light-blocking state 60 and the lightened, light-transmitting state 62. Further, the active sourcing and sinking operation of the drivers as described herein may ensure that the corresponding circuits may be implemented to support the operation of a variety of electrochromic chemistries to control the transition between the transmittance states 60, 62.

Still referring to FIG. 5, the driver 90 may similarly be implemented as one of the dedicated drivers 28 as described in reference to FIGS. 2B and 2C. Implementations with the dedicated drivers 28 supplying the voltage to each of the drive terminals (D+, D−) may differ by independently adjusting the control voltages rather than maintaining the constant voltage associate with the common node 24. Accordingly, implementations with dedicated drivers 28 connected to the drive terminals (D+, D−) may allow for additional control of the voltage difference ΔV applied across each of the electro-optic element 12. Accordingly, the control systems 10 and corresponding circuit configurations disclosed may be implemented in various combinations to suit a wide variety of applications.

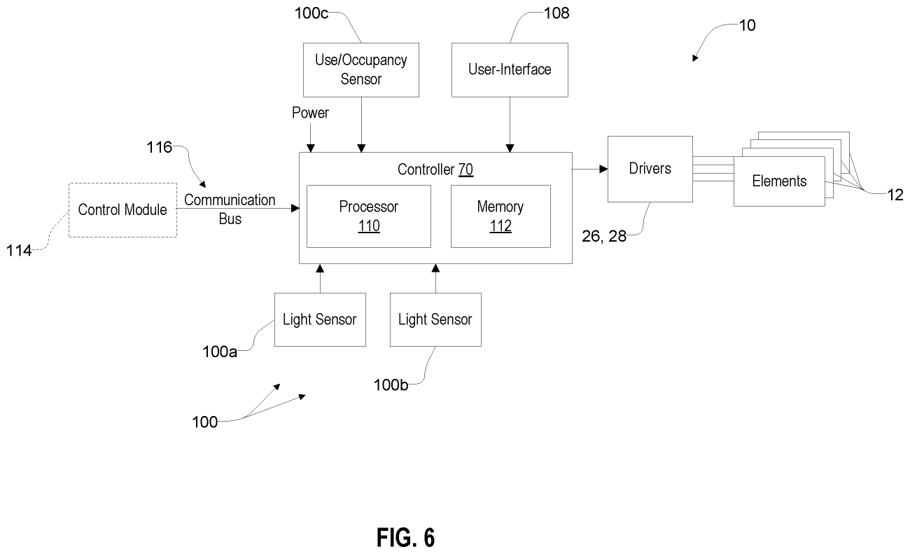

Referring now to FIG. 6, a block diagram of the control system 10 is shown in connection with the common controller 70. As previously discussed, the drivers of the control circuits may be controlled in coordination via the common controller 70. In operation, the controller 70 may be configured to control the transmittance of the electro-optic elements 12 responsive to one or more operating states of the vehicle 30, building 32, wearable device 34, eyewear 36, etc. Additionally, the controller 70 may be in communication with one or more sensors 100 that may detect the operation of one or more light sources or an ambient lighting condition, which may correspond to an operating environment of the control system 10. As described, light sensors may comprise Charge-Coupled Devices (CCD), Complementary Metal-Oxide-Semi-Conductor (CMOS) sensors, photodiodes, or similar technologies. For example, sensors 100 in communication with the controller 70 may include an exterior or ambient light sensor 100a, an interior or auxiliary light sensor 100b, and one or more occupancy or use sensors 100c. In some implementations, the light sensors may correspond to imagers or cameras that may provide for additional operations (e.g., image/video capture) in combination with light sensing. Additionally, the controller 70 of the system 10 may be in communication with a user-interface 108, which may be disposed in connection with the device associated with the operation of the electro-optic elements 12, for example, disposed on a control console, in a passenger compartment, or in connection with a portion of an associated wearable device 34. The user-interface 108 may provide for manual control of the transmittance of one or more of the electro-optic elements 12, as discussed herein.

In various implementations, the central controller 70 may include a processor 110, which may include one or more circuits configured to process data received from the plurality of sensors 100. The processor 110 may be in communication with a memory 112, which may be configured to store various instructions or routines configured to control the transmittance of the electro-optic elements 12 and the associated drivers. The controller 70 may be in communication with a control module 114 via a communication bus 116. The communication bus 116 may be configured to deliver signals to the controller 70 identifying various states of the vehicle 30, building 32, wearable device 34, eyewear 36, etc. Accordingly, the control system 10 may provide for a flexible solution to control the various electro-optic elements 12 in combination.

According to some aspects of the disclosure, an electro-optic apparatus configured to vary in light transmittance comprises a first electro-optic element comprising a first terminal and a second terminal connected across a first electro-optic medium having a first transmittance. A second electro-optic element comprises a third terminal and a fourth terminal connected across a second electro-optic medium having a second transmittance. The first terminal and the third terminal form a common node. A common driver is in conductive connection with the common node to the first terminal and the third terminal, and at least one dedicated driver is in conductive connection with the second terminal of the first electro-optic element. The at least one dedicated driver adjusts the first transmittance by selectively applying a positive voltage difference or negative voltage difference across the first electro-optic medium relative to the common node.

According to various aspects, the disclosure may implement one or more of the following features or configurations in various combinations:
the common driver and the at least one dedicated driver are configured to adjust the first transmittance by alternatively sourcing and sinking a first current;
the common driver operates at a substantially constant control voltage;
at least one dedicated driver selectively adjusts the first transmittance by varying a first output voltage below and above the control voltage;
at least one dedicated driver adjusts the first output voltage over a range of positive voltages;
the range of positive voltages causes a positive voltage difference relative to the control voltage in response to a high state of the at least one dedicated driver;
the range of positive voltages causes a negative voltage difference relative to the control voltage in response to a low state of the at least one dedicated driver;
at least one dedicated drivers comprises a first dedicated driver in conductive connection with the second terminal of the first electro-optic element and a second dedicated driver in conductive connection with the fourth terminal of the second electro-optic element;
the common driver and the second dedicated driver are configured to adjust the first transmittance by alternatively sourcing and sinking a first current;
the second dedicated driver selectively adjusts the second transmittance by varying a second output voltage below and above the control voltage; and/or
the second dedicated driver adjusts the first output voltage over a range of positive voltages.

According to another aspect of the disclosure, a method is provided for independently controlling a transmittance of a plurality of electro-optic elements via conductive contacts including a common control node. The method comprises supplying a consistent common control signal to the common control node and adjusting a first transmittance of a first electro-optic element by selectively applying a positive voltage difference or a negative voltage difference across the first electro-optic medium relative to the common node.

According to various aspects, the disclosure may implement one or more of the following features or configurations in various combinations:
the positive voltage difference corresponds to a range of voltages that adjust the first transmittance over a range of transmittances;
the negative voltage difference corresponds to a range of voltages that adjust a rate of clearing the first transmittance from the range of transmittances;
adjusting a second transmittance of a second electro-optic element by selectively applying the positive voltage difference or the negative voltage difference across the first electro-optic medium relative to the common node;
the common control signal comprises a non-zero voltage supplied consistently throughout the adjustment of the first transmittance and the second transmittance; and/or
a magnitude of the positive voltage difference and the negative voltage difference relative to the common control signal controls a rate of change of the first transmittance.

According to yet another aspect of the disclosure, an electro-optic control apparatus comprises a common driver in conductive connection with a plurality of electro-optic elements, each comprising an electro-optic medium connected via a common node shared between or among the plurality of electro-optic elements, wherein the common driver supplies a common drive signal to the common node of the plurality of electro-optic elements. A plurality of dedicated drivers are in conductive connection with each of the plurality of electro-optic elements via a plurality of independent control nodes connected across at least a portion of the electro-optic medium relative to the common node.

According to various aspects, the disclosure may implement one or more of the following features or configurations in various combinations:
each of the plurality of dedicated drivers is configured to independently control a transmittance state of the corresponding electro-optic element via the independent control node by applying a dedicated control signal having a positive voltage difference or a negative voltage difference relative to the common drive signal; and/or
the common driver operates at a substantially constant control voltage throughout the adjustment of the transmittance states of the electro-optic elements.

It will become apparent to those skilled in the art that various modifications to the preferred embodiment of the invention as described herein can be made without departing from the spirit or scope of the invention as defined by the appended claims.

1. An electro-optic apparatus configured to vary in light transmittance comprising:
a first electro-optic element comprising a first terminal and a second terminal connected across a first electro-optic medium having a first transmittance;
a second electro-optic element comprising a third terminal and a fourth terminal connected across a second electro-optic medium having a second transmittance, wherein the first terminal and the third terminal form a common node;
a common driver in conductive connection with the common node to the first terminal and the third terminal; and
at least one dedicated driver in conductive connection with the second terminal of the first electro-optic element, wherein the at least one dedicated driver adjusts the first transmittance by selectively applying a positive voltage difference or negative voltage difference across the first electro-optic medium relative to the common node.

2. The electro-optic apparatus according to claim 1, wherein the common driver and the at least one dedicated driver are configured to adjust the first transmittance by alternatively sourcing and sinking a first current.

3. The electro-optic apparatus according to claim 1, wherein the common driver operates at a substantially constant control voltage.

4. The electro-optic apparatus according to claim 1, wherein the at least one dedicated driver selectively adjusts the first transmittance by varying a first output voltage below and above the control voltage.

5. The electro-optic apparatus according to claim 4, wherein the at least one dedicated driver adjusts the first output voltage over a range of positive voltages.

6. The electro-optic apparatus according to claim 5, wherein the range of positive voltages causes a positive voltage difference relative to the control voltage in response to a high state of the at least one dedicated driver.

7. The electro-optic apparatus according to claim 6, wherein the range of positive voltages causes a negative voltage difference relative to the control voltage in response to a low state of the at least one dedicated driver.

8. The electro-optic apparatus according to claim 1, wherein the at least one dedicated drivers comprises:
a first dedicated driver in conductive connection with the second terminal of the first electro-optic element; and
a second dedicated driver in conductive connection with the fourth terminal of the second electro-optic element.

9. The electro-optic apparatus according to claim 8, wherein the common driver and the second dedicated driver are configured to adjust the first transmittance by alternatively sourcing and sinking a first current.

10. The electro-optic apparatus according to claim 8, wherein the second dedicated driver selectively adjusts the second transmittance by varying a second output voltage below and above the control voltage.

11. The electro-optic apparatus according to claim 8, wherein the second dedicated driver adjusts the first output voltage over a range of positive voltages.

12. A method for independently controlling a transmittance of a plurality of electro-optic elements via conductive contacts including a common control node, the method comprising:
supplying a consistent common control signal to the common control node; and
adjusting a first transmittance of a first electro-optic element by selectively applying a positive voltage difference or a negative voltage difference across the first electro-optic medium relative to the common node.

13. The method according to claim 12, wherein the positive voltage difference corresponds to a range of voltages that adjust the first transmittance over a range of transmittances.

14. The method according to claim 12, wherein the negative voltage difference corresponds to a range of voltages that adjust a rate of clearing the first transmittance from the range of transmittances.

15. The method according to claim 12, further comprising:
adjusting a second transmittance of a second electro-optic element by selectively applying the positive voltage difference or the negative voltage difference across the first electro-optic medium relative to the common node.

16. The method according to claim 15, wherein the common control signal comprises a non-zero voltage supplied consistently throughout the adjustment of the first transmittance and the second transmittance.

17. The method according to claim 12, wherein a magnitude of the positive voltage difference and the negative voltage difference relative to the common control signal controls a rate of change of the first transmittance.

18. An electro-optic control apparatus comprising:
a common driver in conductive connection with a plurality of electro-optic elements, each comprising an electro-optic medium connected via a common node shared between or among the plurality of electro-optic elements, wherein the common driver supplies a common drive signal to the common node of the plurality of electro-optic elements; and
a plurality of dedicated drivers in conductive connection with each of the plurality of electro-optic elements via a plurality of independent control nodes connected across at least a portion of the electro-optic medium relative to the common node.

19. The electro-optic control apparatus according to claim 18, wherein each of the plurality of dedicated drivers is configured to independently control a transmittance state of the corresponding electro-optic element via the independent control node by applying a dedicated control signal having a positive voltage difference or a negative voltage difference relative to the common drive signal.

20. The electro-optic apparatus according to claim 19, wherein the common driver operates at a substantially constant control voltage throughout the adjustment of the transmittance states of the electro-optic elements.
